(19) United States
(12) Patent Application Publication
(10) Pub. No.: US 2014/0020943 A1
(43) Pub. Date: Jan. 23, 2014

(54) CAPACITOR AND MULTILAYER CIRCUIT BOARD USING SAME

(71) Applicant: HON HAI PRECISION INDUSTRY CO., LTD., New Taipei (TW)

(72) Inventors: YING-TSO LAI, New Taipei (TW); HSIAO-YUN SU, New Taipei (TW)

(73) Assignee: HON HAI PRECISION INDUSTRY CO., LTD., New Taipei (TW)

(21) Appl. No.: 13/944,868

(22) Filed: Jul. 17, 2013

(30) Foreign Application Priority Data
Jul. 19, 2012 (TW) 101126080

(51) Int. Cl. H01G 4/40

(52) U.S. Cl. CPC H01G 4/40
USPC 174/260; 361/306.1; 361/301.4

(57) ABSTRACT

A capacitor includes a first patterned conductive layer, a second patterned conductive layer and a patterned dielectric layer. The first patterned conductive layer is interlaced with the second patterned conductive layer in one plane so as to present, within the smallest overall volume, the greatest surface area of one conductive layer in the closest proximity to the parts of the second conductive layer. The patterned dielectric layer is within a same plane as the first and second patterned conductive layers and in fills all gaps between the first and second patterned conductive layers to form a capacitor between the first and second conductive layers. The first and second patterned conductive layer and the patterned dielectric layer are stacked within and contained by a multilayer circuit board.

### BACKGROUND

1. Technical field

The disclosure generally relates to a capacitor and a multilayer circuit board using the capacitor.

2. Description of the Related Art

A capacitor on a circuit board may include two opposite metal layers and a dielectric layer positioned between the two opposite metal layers. Capacitance of the capacitor is proportional to an area of the metal layers, and is inversely proportional to a thickness of the dielectric layer. That is, capacitance of the capacitor can be improved by increasing the area of the metal layers or by decreasing thickness of the dielectric layer. However, increasing the area of the metal layers may cause the capacitor to occupy much more space, and decreasing the thickness of the dielectric layer may affect impedance matching with other circuits of the circuit board.

Therefore, there is room for improvement within the art.

### BRIEF DESCRIPTION OF THE DRAWINGS

Many aspects of an exemplary capacitor and multilayer circuit board can be better understood with reference to the following drawings. The components in the drawings are not necessarily drawn to scale, the emphasis instead being placed upon clearly illustrating the principles of the exemplary capacitor and multilayer circuit board. Moreover, in the drawings, like reference numerals designate corresponding parts throughout the several views. Wherever possible, the same reference numbers are used throughout the drawings to refer to the same or like elements of an embodiment.

FIG. 1 is a schematic view of a capacitor according to an exemplary embodiment of the present disclosure.

FIG. 2 is an exploded view of a first conductive layer of the capacitor shown in FIG. 1.

FIG. 3 is a plan view of a first conductive layer and a third conductive layer of the capacitor shown in FIG. 1.

FIG. 4 is a plan view of a second conductive layer and a fourth conductive layer of the capacitor shown in FIG. 1.

FIG. 5 is a cross-sectional view of the capacitor taken along line V-V of FIG. 1.

FIG. 6 is a schematic view of a multilayer circuit board according to an exemplary embodiment of the present disclosure.

### DETAILED DESCRIPTION

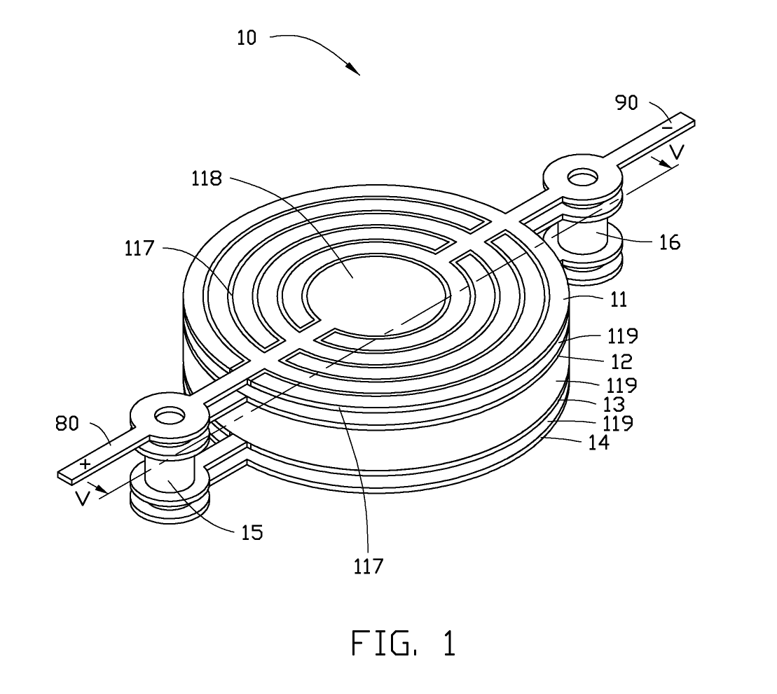

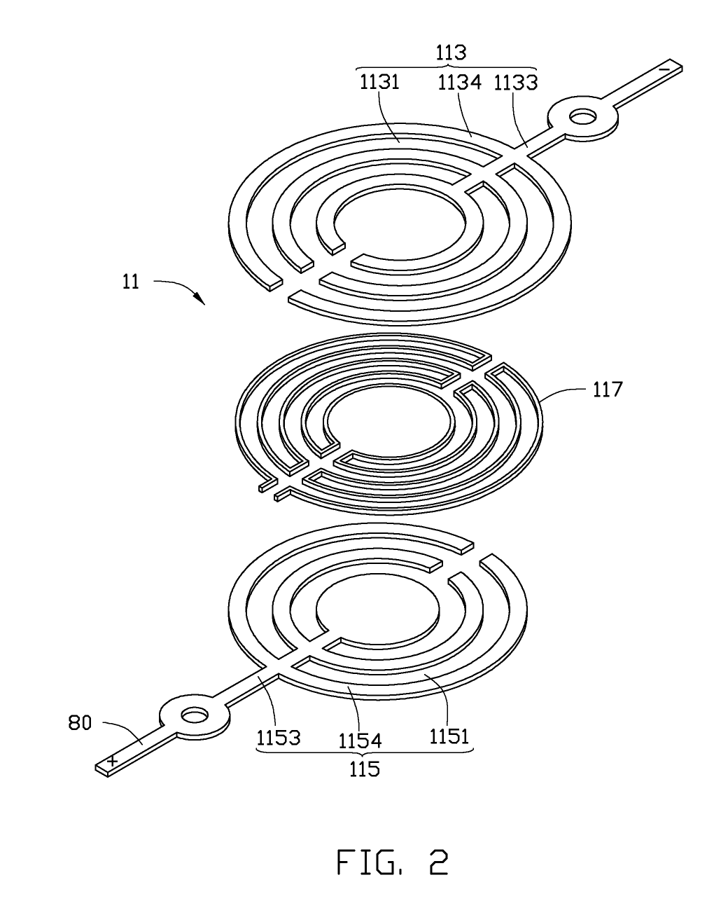

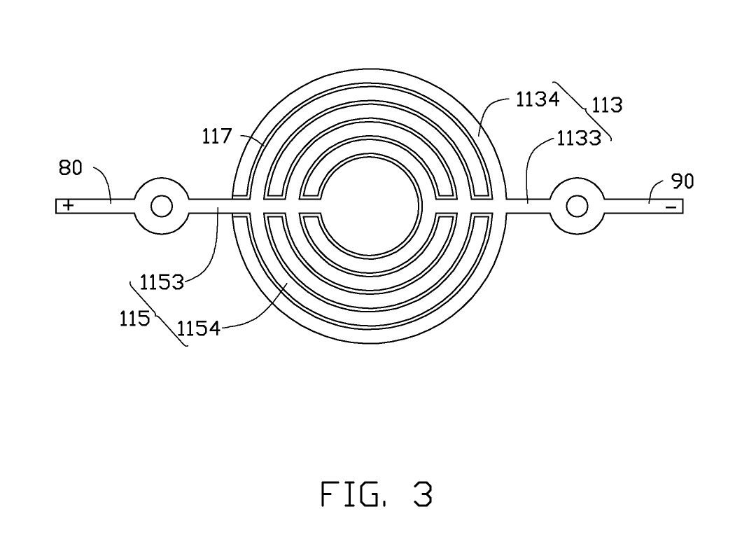

Referring to FIGS. 1-3, a capacitor 10 according to an exemplary embodiment is shown. The capacitor 10 includes at least two conductive layers positioned by being stacked on each other and in close proximity to each other, and a dielectric layer 119 positioned between each two conductive layers. In this exemplary embodiment, the capacitor 10 includes four stacked conductive layers, with the dielectric layer 119 positioned between each two conductive layers. The four conductive layers are a first conductive layer 11, a second conductive layer 12, a third conductive layer 13, and a fourth conductive layer 14. Each of the four conductive layers 11, 12, 13 and 14 includes a positive electrode 80 and a negative electrode 90. The positive electrodes 80 are electrically connected to each other through a first connector 15 to form a positive electrode of the capacitor 10. A positive voltage is provided to the capacitor 10 through the positive electrode of the capacitor 10. The negative electrodes 90 are electrically connected to each other through a second connector 16 to form a negative electrode of the capacitor 10. A negative voltage is provided to the capacitor 10 through the negative electrode of the capacitor 10. The first conductive layer 11 has a same shape as the third conductive layer 13, and the second conductive layer 12 has a same shape with the fourth conductive layer 14.

The first conductive layer 11 includes a first patterned conductive layer 113, a second patterned conductive layer 115, and a patterned dielectric layer 117. The first patterned conductive layer 113 includes a first connecting portion 1133 and a plurality of first branch portions 1134. The first connecting portion 1133 connects to the negative electrode 90 to receive the negative voltage, and the first connecting portion 1133 is strip shaped. The plurality of first branch portions 1134 radiate from two opposite sides of the first connecting portion 1133. The plurality of first branch portions 1134 may be spaced substantially evenly, and the plurality of the first branch portions 1134 are arc shaped. The first connecting portion 1133 and the plurality of first branch portions 1134 are coplanar. The first connecting portion 1133 and the plurality of first branch portions 1134 define a plurality of first openings 1131.

The second patterned conductive layer 115 has a shape corresponding to the first openings 1131 defined in the first patterned conductive layer 113. In detail, the second patterned conductive layer 115 includes a second connecting portion 1153 and a plurality of second branch portions 1154. The second connecting portion 1153 connects to the positive electrode 80 to receive the positive voltage, and the second connecting portion 1154 is strip shaped. The plurality of second branch portions 1154 radiate from two opposite sides of the second connecting portion 1153. The width of each of the plurality of second branch portions 1154 is a slightly less than the width of each of the plurality of first openings 1131. The plurality of first branch portions 1154 may be spaced substantially evenly. The second branch portions 1154 in the middle of the plurality of second branch portions 1154 is round, and the other second branch portions 1154 are arc shaped. The second connecting portion 1153 and the plurality of the second branch portions 1153 are coplanar. The second connecting portion 1153 and the plurality of second branch portions 1154 define a plurality of second openings 1151, and the width of each of the plurality of second openings 1151 is a slightly greater than the width of each of the plurality of first branch portions 1134.

The second patterned conductive layer 115 and the patterned dielectric layer 117 are located within the first openings 1131. The patterned dielectric layer 117 is sandwiched between the first patterned layer 113 and the second patterned layer 115. The first patterned conductive layer 113, the second patterned conductive layer 115 and the patterned dielectric layer 117 are in a same horizontal plane, thus those three elements together have a depth, or vertical displacement, which is not greater than the depth of a single one. In detail, each of the plurality of second branch portions 1154 is located to correspond to each of the first openings 1131, and each of the plurality of first branch portions 1134 is located to correspond to each of the second openings 1151. Therefore, a plurality of gaps exist between the first patterned conductive layer 113 and the second patterned conductive layer 115. The patterned dielectric layer 117 is positioned so as to infill the plurality of gaps to create a capacitive arrangement and capability between the first patterned conductive layer 113 and the second patterned conductive layer 115.

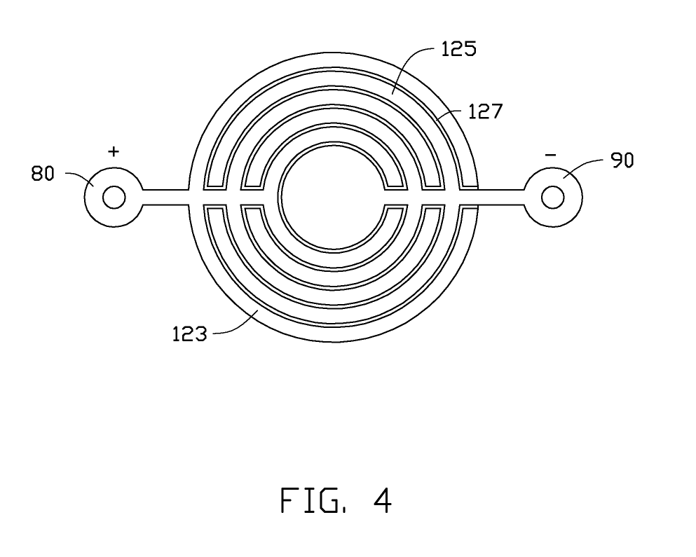

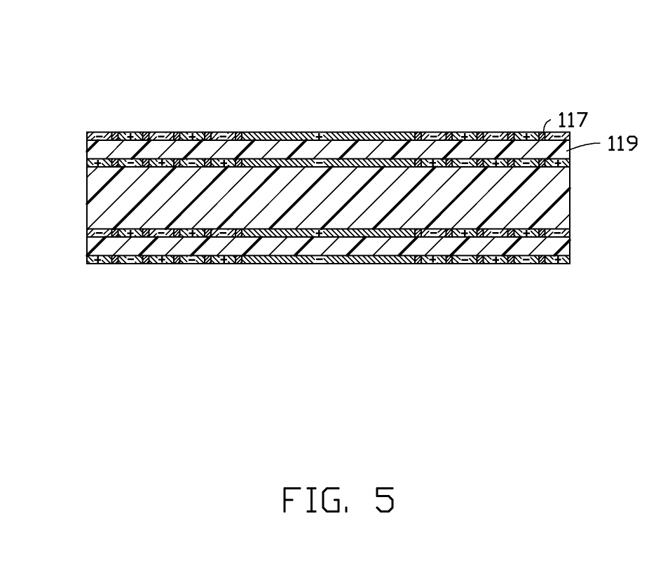

Referring to FIG. 4 and FIG. 5, FIG. 4 is a plan view of the second conductive layer 12 and the fourth conductive layer 14 of the capacitor 10 shown in FIG. 1. FIG. 5 is a cross-sectional view taken along line V-V of the capacitor 10 shown in FIG. 1. The second conductive layer 12 includes a third patterned conductive layer 125, a fourth conductive layer 123 and a patterned dielectric layer 127. The third patterned conductive layer 125, the fourth conductive layer 123 and the patterned dielectric layer 127 are coplanar. Materials, dimensions, and functions of the third patterned conductive layer 125, the fourth patterned conductive layer 123 and the patterned dielectric layer 127 are in all respects substantially identical to those of the first patterned conductive layer 113, the second patterned conductive layer 115 and the patterned dielectric layer 117 respectively.

The first conductive layer 11, the second conductive layer 12, the third conductive layer 13 and the fourth conductive layer 14 are stacked from top to bottom, in that order, with the dielectric layer 119 between coplanar conductive layers which are in close proximity. Each branch portion provided with the positive voltage of one patterned conductive layer is opposite to the branch portion provided with the negative positive voltage of the other adjacent patterned conductive layer. Each branch portion provided with the negative voltage of one patterned conductive layer is opposite to the branch portion provided with the positive voltage of the other adjacent patterned conductive layer (as shown in FIG. 5).

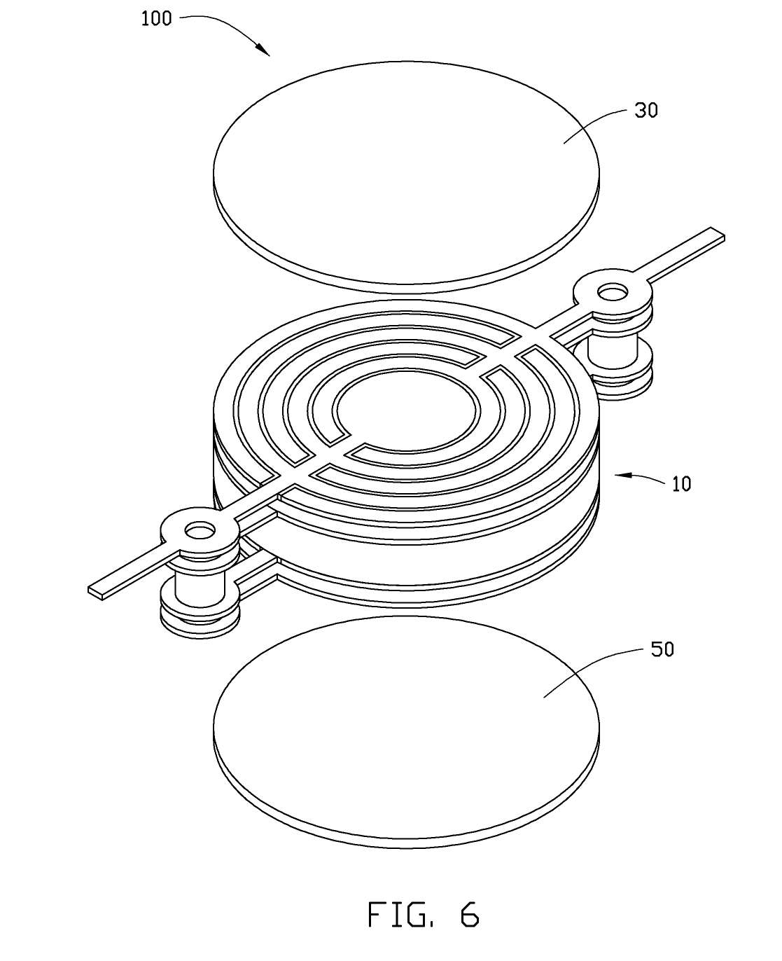

FIG. 6 is a schematic view of the multilayer circuit board 100 according to an exemplary embodiment of the present disclosure. The multilayer circuit board 100 includes a top layer 30, a bottom layer 50 and the capacitor 10. Each layer of the capacitor 10 is between the top layer 30 and the bottom layer 15. The top layer 30 and the bottom layer 50 cover and enclose the capacitor 10 together. The top layer 30 and the bottom layer 50 are dielectric layers, and the wires (not shown) are positioned on the surface of the top layer 30 and the bottom layer 50 for electronic coupling to electronic components positioned on the surface of the top layer 30 and the bottom layer 50.

Each of the patterned conductive layer includes a plurality of branch portions provided with the positive voltage interlaced with a plurality of branch portions provided with the negative voltage. There are electrical fields created between the branch portions provided with the positive voltage and the branch portions provided with the negative voltage in the same coplanar layer. Therefore, the capacitance of the capacitor is increased without changing the size of the capacitor. Furthermore, the capacitor is in itself a multilayer component, and can be located within a multilayer circuit board so the individual coplanar layers correspond to the multiple layers of the multilayer circuit board, hence a wiring and other space of the multilayer circuit board is saved.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A capacitor, comprising:
a first patterned conductive layer comprising a first connecting portion for receiving a first polarized voltage and a plurality of first branch portions extending form two opposite sides of the first connecting portion;
a second patterned conductive layer having a second connecting portion for receiving a second polarized voltage and a plurality of second branch portions extending from two opposite side of second connecting portion;
a patterned dielectric layer;
wherein the plurality of first branch portions and the plurality second branch portions are coplanar and interlace with each other, and a plurality of gaps are formed between each of the plurality of first branch portions and the adjacent second branch portions, and the patterned dielectric layer is located in the plurality of gaps; the first patterned layer, the second patterned layer and the patterned dielectric layer are coplanar.

2. The capacitor according to claim 1, wherein the first patterned conductive layer is electrically coupled to a positive electrode providing a positive voltage, the second patterned conductive layer is electronically coupled to a negative electrode providing a negative voltage.

3. The capacitor according to claim 2, wherein the capacitor further comprises a first connector and a second connector, the first patterned conductive layer is electronically coupled to the positive electrode via the first connector, and the second patterned conductive layer is electronically coupled to the negative via the second connector.

4. The capacitor according to claim 1, wherein the first connecting portion is strip shaped and the plurality of first branch portions are arc shaped, the first connecting portion and the plurality of first branch portions are coplanar and defining a plurality of first openings.

5. The capacitor according to claim 4, wherein the plurality of first branch portions are spaced evenly.

6. The capacitor according to claim 4, wherein the second connecting portion is strip shaped, the second branch portions in the middle of the plurality of second branch portions is round, the other second branch portions are arc shaped, the second connecting portion and the plurality of second branch portions define a plurality of second openings, the width of each of the plurality of second branch portions is less than the width of corresponding first opening, and the width of each of the plurality of second openings is greater than the width of corresponding first branch portion.

7. The capacitor according to claim 6, wherein the plurality of second branch portions are spaced evenly.

8. A multilayer circuit board, comprising:
a top layer;
a bottom layer; and
a capacitor positioned between the top layer and the bottom layer;
the capacitor comprising:
a first patterned conductive layer comprising a first connecting portion and a plurality of first branch portions extending form two opposite sides of the first connecting portion;
a second patterned conductive layer having a second connecting portion and a plurality of second branch portions extending from two opposite side of second connecting portion;
a patterned dielectric layer;
wherein the plurality of first branch portions and the plurality of second branch portions interlace with each other, and a plurality of gaps are formed between each of the plurality of first branch portions and the adjacent second branch portions, and the patterned dielectric layer is located in the plurality of gaps; the first patterned layer, the second patterned layer and the patterned dielectric layer are coplanar.

9. The multilayer circuit board according to claim 8, wherein the first patterned conductive layer is electronically coupled to a positive electrode providing a positive voltage, the second patterned conductive layer is electronically coupled to a negative electrode providing a negative voltage.

10. The multilayer circuit board according to claim 9, wherein the capacitor further comprises a first connector and a second connector, the first patterned conductive layer is electronically coupled to the positive electrode via the first connector, the second patterned conductive layer is electronically coupled to the negative via the second connector.

11. The multilayer circuit board according to claim 9, wherein, the first connecting portion is strip shaped and the plurality of first branch portions are arc shaped, the first connecting portion and the plurality of first branch portions are coplanar and defining a plurality of first openings.

12. The multilayer circuit board according to claim 11, wherein the plurality of first branch portions are spaced evenly.

13. The multilayer circuit board according to claim 11, wherein the second connecting portion is strip shaped, the second branch portions in the middle of the plurality of second branch portions is round, the other second branch portions are arc shaped, the second connecting portion and the plurality of second branch portions define a plurality of second openings, the width of each of the plurality of second branch portions is less than the width of corresponding first opening, the width of each of the plurality of second openings is greater than the width of corresponding first branch portion.

14. The multilayer circuit board according to claim 13, wherein the plurality of the second branch portions are spaced evenly.

15. A capacitor, comprising:
at least two stacked conductive layers; and
at least one dielectric layer positioned between each two adjacent conductive layers of the at least two stacked conductive layers;
wherein at least one conductive layer comprises a first patterned conductive layer, a second patterned conductive layer and a patterned dielectric layer;
the first patterned conductive layer is provided with a first polarized voltage, and the second patterned conductive layer is provided with a second polarized voltage;
the first patterned conductive layer comprises a first connection portion for receiving the first polarized voltage, a plurality of first branch portions extending from the first connection portion and electronically connecting with the first second connection portion, and a plurality of first openings defined by the first connection portion and the plurality of first branch portions;
the second patterned conductive layer comprises a second connection portion for receiving the second polarized voltage, a plurality of second branch portions extending form two opposite sides of the second connection portion and electrically connecting with the second connection portion;
the plurality of second branch portions are coplanar with the plurality of first branch portions and are positioned in the plurality of first openings, and the patterned dielectric layer is located between the first patterned conductive layer and the second conductive layer; the first patterned conductive layer, the first patterned conductive layer of one conductive layer corresponds to the second patterned conductive layer of a most adjacent conductive layer in a stack direction.

16. The capacitor according to claim 15, wherein the capacitor further comprises a first connector and a second connector, each of the first patterned conductive layers of each conductive layers is electronically connected each other via the first connector to receive the first polarized voltage, each of the second patterned conductive layers of each conductive layers is electronically connected each other via the second connector to receive the second polarized voltage.

17. The capacitor according claim 15, wherein the first connecting portion is strip shaped and the plurality of first branch portions are arc shaped.

18. The capacitor according claim 15, wherein the plurality of first branch portions are spaced evenly.

19. The capacitor according to claim 15, wherein the second connecting portion is strip shaped, the second branch portions in the middle of the plurality of second branch portions is round, the other second branch portions are arc shaped, the width of each of the plurality of second branch portions is less than the width of each of the plurality of first openings, the width of each of the plurality of second openings is greater than the width of each of the plurality of first branch portions.

20. The capacitor according to claim 19, wherein the plurality of second branch portions are spaced evenly.
